(19) United States
(12) Patent Application Publication
(10) Pub. No.: US 2012/0061968 A1
(43) Pub. Date: Mar. 15, 2012

(54) BURRELL COMPOUND AXIAL WINDMILL

(76) Inventor: Leo LeRoy Burrell, (US)

(21) Appl. No.: 12/879,811

(22) Filed: Sep. 10, 2010

(51) Int. Cl. F03D 9/00; F03D 7/02

(52) U.S. Cl. 290/55; 416/10

(57) ABSTRACT

A plurality of sail assemblies rotating on their axes rotate about the axis of the windmill hub to rotate a drive shaft. The drive shaft powers a generator, machine, pump, grind-stone or other load the mill is designed to operate. Fabric, metal, or plastic sails are fitted to the frame arms of the sail assembly such that they are releasable under upset conditions such as hurricane or tornado wind velocities or other catastrophic inclusion. In the preferred embodiment of the invention drive shafts housed in tubular metal, plastic, or fiberglass connect the gears of the hub to helical or bevel type right angle gearboxes that rotate the sails at a rate of one time for each two times the hub rotates. A second embodiment of the mill has sprockets at the sail assemblies which drive a sprocket at the hub of the mill. The sprockets are rotated one time for each revolution of the hub sprocket via a roller chain. And the sail assemblies rotate in the same direction as the rotation of the hub sprocket. Other embodiments of the construction of the Burrell pattern Compound Windmill are contemplated. One such embodiment of the mill is mounted in a stream or river, and power is transmitted upward to a platform where a generator or other equipment perform work. Another variation of construction substantially uses parts commonly found in scrapped automobiles—permitting inexpensive windmills in villages in third-world countries where commercial electrical power is either too expensive or not available. Constant Velocity (CV) joints, wheels, alternators, power steering pumps, etc. can be salvaged, and a mill can be designed by a technician trained in that discipline.

### REFERENCES

U.S. Pat. No. 7,780,416 B2 * Aug. 24, 2010 Al-Azzawi . . . 416/111

U.S. Pat. No. 1,286,853 A * December 1918 Weaver . . . 416/50

U.S. Pat. No. 3,920,354 A * November 1975 Decker . . . 416/117

U.S. Pat. No. 4,365,935 A * December 1982 Zukeran . . . 416/117

U.S. Pat. No. 4,649,284 A * March 1987 Hsech-Pen . . . 290/55

U.S. Pat. No. 7,413,404 B2 * Aug. 19, 2002 Chuy-Nan Chie . . . 416/17; 416/116; 416/132 B; 415/4.2

U.S. Pat. No. 7,344,353 B2 * Mar. 18, 2008 Pertti H. Naskali, Angus MacLean, C. C. Gray, Lewis, Newall . . . 415/4.2; 415/71;

U.S. D591,234 S * Apr. 28, 2009 Yuji Unno D13/115; D13/118, 122, 199

U.S. Pat. No. 7,540,705 B2 * Jan. 2, 2009 Garry Emshey . . . 415/4.1; 415/4, 127; 416/198 R, 228, 197 R

U.S. Pat. No. 7,618,237 B2 * Nov. 17, 2008 Brandon W. Lucas, Daniel W. Lucas . . . 416/119; 416/132 B; 416/140

U.S. Pat. No. 7,632/069 B2 * Dec. 15, 2009 Gene Ryland Kelley . . . 416/80; 416/82; 416/83; 414.4.2

U.S. Pat. No. 7,726,934 B2 * Jan. 1, 2010 Orville Gideon Cowan . . . 415.42; 415/4.4; 415/907

U.S. Pat. No. 7,766,601 B2 * Aug. 3, 2010 Firmiliano M. Vida Marques . . . 415/4.2;4; 415/907

U.S. Pat. No. 7,766,601 B2 * Aug. 3, 2010 Firmiliano M. Vida Marques . . . 415/4.2; 415/4.4; 415/17; 415/48; 416/17

### BACKGROUND OF THE INVENTION

Windmills, as they are known in the art have substantially been one of three constructions; the Savonius Mill, the Propeller Mill, and the Egg-beater Mill. While these in their several embodiments do important work, they have their limits. Propeller Mills are generally aligned on hills overlooking ocean shore-lines or where air rises up a hill. The Savonius Mill, of which the Vane Anemometer is a type only produce power to the cup side—expecting the shape of the backside of the cup to have as little counter-effect as possible. The Egg-beater mills are also a type of vertical turbine which is counter-productive on the blades upwind side.

A recent windmill invention—the “Blinking Sail Windmill” shows some effort to reduce the effect of drag on the sails in the upwind direction. While it seems to be some improvement over previous vertical mills, the turbulence of loose sails flapping in the wind would be detrimental. Such conventional wisdom admits that power can only be generated on half of a rotation cycle. All effort to date has been to limit upwind losses.

One drawback to giant propeller windmills is the cost. Individuals can ill-afford one; the cost has to be absorbed by an entire community. Another drawback is the sweep of the blades which brings them so close to the ground that their effect is reduced through a third of their rotation. Another drawback is the cost of maintenance. The mill-head is so high in the air, and the components so complicated that the average citizen wouldn't qualify or desire to work on them; the cost of maintenance is a burden only a community—through the local Electric Company can afford.

None of the vertical axis windmills I researched make any effort to gain power on the lee or quarter side of the mill. Sails or vanes are designed to be as little detriment upwind as possible until they face windward.

### BRIEF SUMMARY OF THE INVENTION

The BURRELL COMPOUND VERTICAL AXIS WINDMILL sails actually contribute to the power on the lee or quarter side of the mill. There are no losses of a returning sail such as are experienced with ordinary vertical axis windmills. When we first designed it, we used airfoil that keeps an airplane aloft to contribute power to the mill in the critical leeward to windward half of the rotation. We still have the technology to warp the two-faced sails so as to create airfoil, but further testing is needed. The sails of this invention face fully into the wind in the windward direction, and contribute variously as a tacking sailboat does—developing more force than a spinnaker driving downwind. The thrust developed when the sails of this invention are disposed quarterly with the wind and quarterly into the wind actually contribute more to the mill's velocity than when they face the wind. The wind attacking the sails progressively from the windward quarter through the windward alignments is warped in its direction such that it drives more forcefully against the sails in the leeward quarter alignment. The BURRELL pattern COMPOUND WINDMILL can be mounted: on a pole in a person's backyard; on a stout house roof, or in the median between roadways. And in its preferred embodiment it will be positioned as 100 kw or larger units at every rest area on every Interstate highway in America; in rural areas of India, China, Africa, and on every island of every ocean around the globe. As the world moves toward electric cars it will be a comfort to know a person is close to public facilities to recharge their car when they are traveling. People will have these windmills installed near their homes to provide 10 kw of power that is more than enough to provide for their needs, and they will share with neighbors or sell their excess to the local Utility Company. As windmills proliferate, the need for coal-fired power plants will be a memory. Even Nuclear Power—which is today's best alternative to coal, will cease to be built for lack of need. While the Production Model of the BURRELL COMPOUND VERTICAL AXIS WINDMILL is attractive for its diversity, it is a model for windmill construction using reclaimed auto parts in third-world countries. To bring electricity or the ability to grind grain or pump water in the rural areas of every continent will elevate the life-style of all of earth's community. While the compound windmill of the present disclosure can be of great value around the world we believe there is a benefit in setting it below the surface of every river to provide power where there is no room for a tower or where the Jet Stream or other laminar air-flow is too little/too high/too distant to be of value to a particular community. The principle advantage of the BURRELL STREAM MILL is in the power generating capability of a moving liquid that is more effective than that of a gas (air). A second advantage is in that water—even in times of flood, moves in a predictable direction at a predictable flow-rate. Streams and rivers present some obstacle from flotsam moving downstream, but a weir can be constructed to divert such obstacles. The sails of such mill will be made of durable corrosion-resistant material and the mill will be more compact. The danger posed by boating and other uses of the river or stream would be minimized by the super-structure's presence above the water. There is a really long stretch of the Detroit River for example where the northbound and southbound channels deny a lot of secondary use. Mills could be place there between the islands that would substantially benefit both U.S. and Canadian communities.

LOOKING FORWARD, since the giant Propeller Windmills have their place on hills where the wind sweeps upward—but they are limited to that application, it will appear obvious to the casual observer that only a vertical axis windmill that operates regardless of the direction of the wind will suffice at every Rest Area on every Interstate Highway in the United States to provide power to charge electric automobiles and trucks. A Grid will connect all these generating stations so that power can be had at a rest area where its mill isn't producing electricity at that time. Other uses for the BURRELL COMPOUND VERTICAL AXIS WINDMILL are contemplated, and the foregoing doesn't limit its development.

### BRIEF DESCRIPTION OF THE DRAWINGS

FIG. 1 shows the relationship between the sail assemblies and the hub wherein a continuous roller chain engaging the hub sprocket 1 also engages each of the sail assembly sprockets 2. The size and pitch of the chain 3 and sprockets 2 and bevel gears 4 varies as the size of the Mill varies to produce the torque necessary to turn any particular load—whether electrical generator, grain grinder, or pump. The hub 1 makes two complete revolutions for each complete revolution of the sail assembly sprockets 2 and bevel gears 4. The ratio then between sail assembly rotation and hub rotation is 1:2. This ratio is the same regardless what means is used to orient the sails to the hub—whether a tail, wind direction sensing electronic device, or other means. The sail assemblies are attached to the hub 1 by support arms 10 of a suitable length to the sail right-angle gear boxes (shown in another Figure). One device for aiming the mill into the wind is shown here—a tail assembly 8 firmly fastened to and becoming part of the hub sprocket 1 around which the chain 3. The hub sprocket 1/tail 8 assembly is the reference that determines the set of the sails via the chain 3 rotating the sail assembly sprockets 2 such that the mill is always oriented to face the wind. The flutes 9 of the tail assembly 8 are more effective in orienting the mill than is a straight tail. Other tail styles are contemplated. A tail is a tail, and this is one style. The hub sprocket/tail assembly 1/8 doesn't rotate with the mill axle 5; the mill axle 5 rotates within the double race bearings 6, 7 that separates it from the sprocket/tail assembly. In a basic model of this mill, facing a constant known wind direction wouldn't have a tail or other wind direction facing device. The hub sprocket 1 would be firmly fastened to the tower and the mill would rotate around the tower—its axis 5 rotating within double race roller bearings on thrust bearings (shown in FIG. 4).

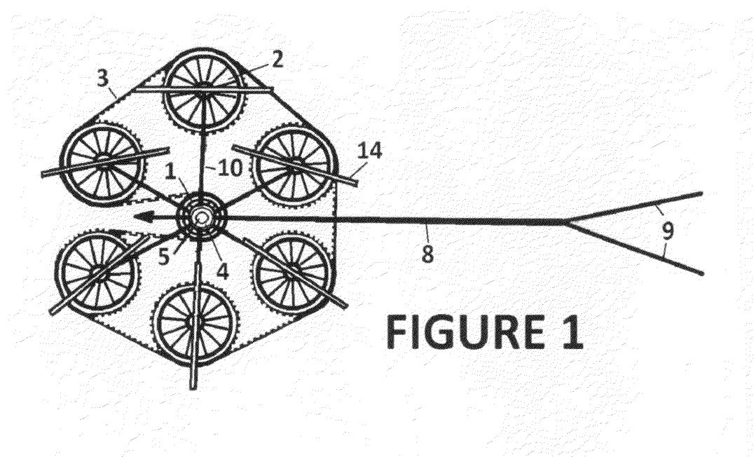

FIG. 2 is an overhead perspective of the BURRELL pattern COMPOUND WINDMILL showing a steel framed tower 21. Other tower styles such as are commonly used in power transmission are contemplated as well as utility poles, light poles, and those fabricated of lumber, plastic, and concrete. The hub 1 (detailed in FIG. 3) contains the gearing mechanism that rotates the sail assemblies whereas the mill illustrated in this figure is rotated at the mill drive shaft 20 by a DC Motor 18 controlled by a wind-direction sensing device (not shown) whereas a mechanical sail rotating device is detailed in FIG. 3. Hollow metal, Fiberglas, or plastic arms 13 contain drive shafts that connect the sail assembly right-angle gear boxes 11 to the gears in the hub 1. The gear boxes 11 rotate the sail frames 12 which support fabric, metal, or plastic sails 14. Cables 16 connect the sail assemblies to provide support against flexing due to uneven wind force against the sails 14. Other cables 17 extend from the mast 15 to the arms 13 to provide support for the sail assemblies against vertical loads, e.g., the weight of the sail assemblies. A plurality of sail assemblies—typically, 3, 4 (or 6 as shown in this figure) are acted upon by wind force to progressively change attitude as they rotate about the mill-head 5—thereby rotating the power shaft 20 which operates on the load 19 such as a grain mill, pump, generator, or other load. Large electrical generating mills are contemplated whose towers 21 may reach more than 100 ft. tall and have arms 13 that are more than 30 ft long supporting sails 14 that are larger than 30 square feet in area.

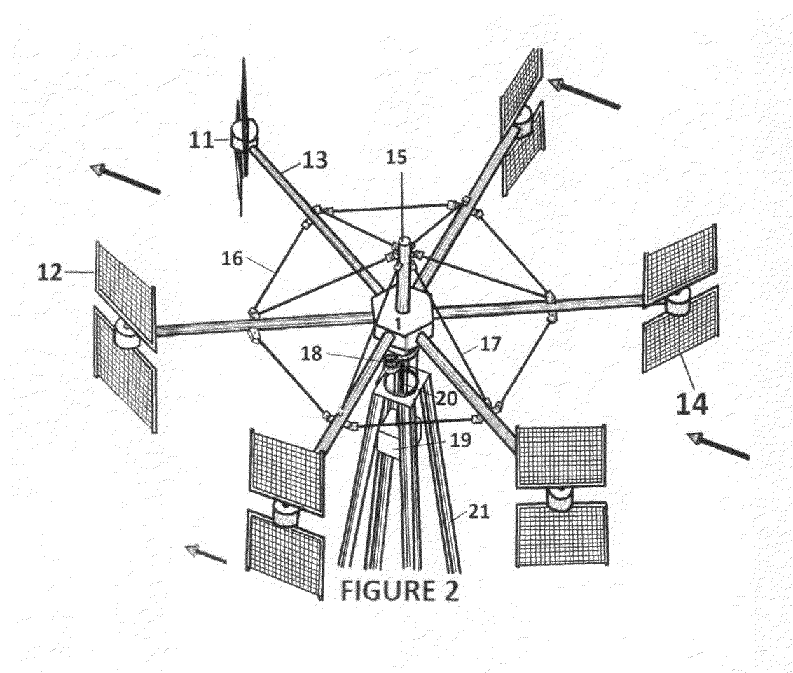

FIG. 3 is an illustration of how the Burrell Compound Vertical Axis Windmill is presented “at-rest.” The dashed line 28 represents the balance line of the mill at the universal joint (or continuous velocity “CV” joint) 27—the “balance point.” The epicenter of the weight of the mill is below the balance line, but the mill has a greater sail surface area 14 above the balance line 28 than that which is below it 29. Therefore, when the wind blows against the windward facing sails they tend to lift—tipping the mill back. As the wind becomes progressively forceful the mill will progressively yield to it—providing a more stable influence at the drive shaft 20 than a non-yielding mill will provide. There is a maximum effectiveness at any wind speed, and the amount of sail imbalance 14:29 must be calculated for every manufactured windmill so that no useable power is lost to inefficiency. As the mill tilts back on its hinge 27 it progresses to an upset condition where the sails are presented in-line with the wind and become totally ineffective. Since there is no relief to resist the force of a hurricane or tornado force, the sail material may be designed to detach under severe conditions. One such means is the use of fabric sails that slip over the arms of the sail frame assemblies 12. Support cables 17 extend from the mast 15 to the sail assembly extension arms 13 so as to enable use of lighter gage tubing for the arms 13. A convenient feature of the Burrell windmill is tipping of the mill-head to present the axle 20 in a horizontal alignment so that the sail assemblies can be rotated downward to a platform attached to the tower frame 21 on which a technician can perform maintenance of the sail assemblies.

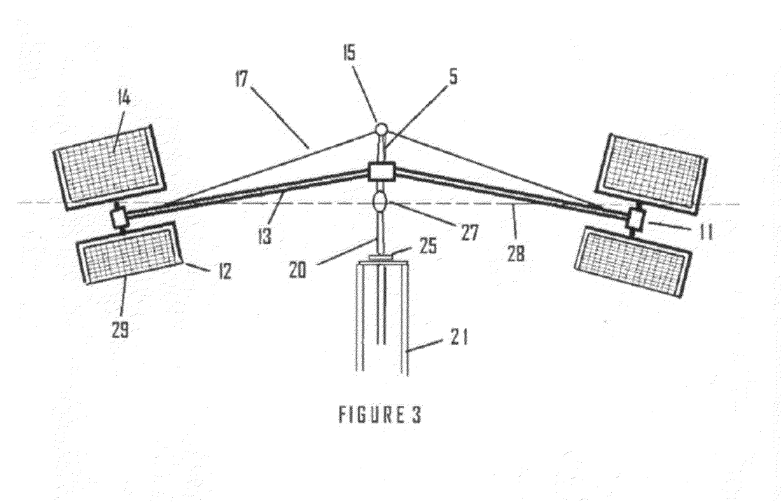

FIG. 4 is a detail of one means of rotating the BURRELL COMPOUND VERTICAL AXIS WINDMILL. A hub assembly 5 has virtually the same elements illustrated in FIG. 1 contained therein, and includes a continuous double roller chain 3 that rolls about the stationary hub double sprocket 1 and a plurality of rotatable sail assembly double sprockets 2 fixed to bevel gears 4 engaged by bevel gears 22 that are rotated by the sail assembly drive shafts 23. The vertical mill axle shaft 20 rotates freely within the hub sprocket 1 on bearings 25. In this drawing the axle passes through bearings 25 of the hub 5 and becomes the mast 15 to which sail assembly support cables 17 are attached. Other hubs 5 are contemplated whose axle ends in a bearing block at the top of the hub 5. Hubs of that design will have masts 15 attached to the hub to provide cable support 17 of their sail assembly extension arms 13.

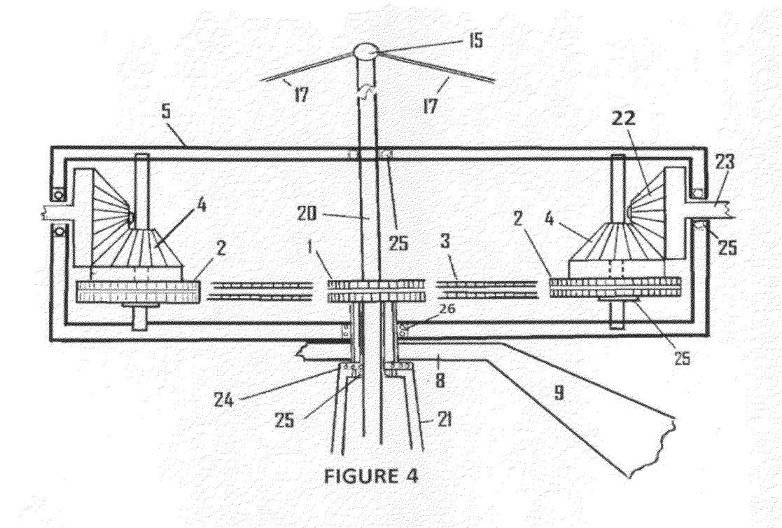

FIG. 5 illustrates one of a plurality of sail assemblies having drive shafts 23 housed in the support arms 13 engaging double input/single output right angle gearboxes 11 at the sail assembly. At the hub end the drive shafts 23 couple via universal joints 24 through bearing blocks 25 to bevel gears 22 of the hub 5. Sail frames 12 are attached to the shafts of the gear boxes 11 to provide support for sails 14. Support cables 17 from the mast 15 attach to the support arms 13 at collars 26. Only one such cable is shown in this drawing, but a plurality of cables 17 may be required to support very long arms 13. Depending on power requirements, the number and size of the sail assemblies and the number of input gear assemblies at the hub 5 will vary.

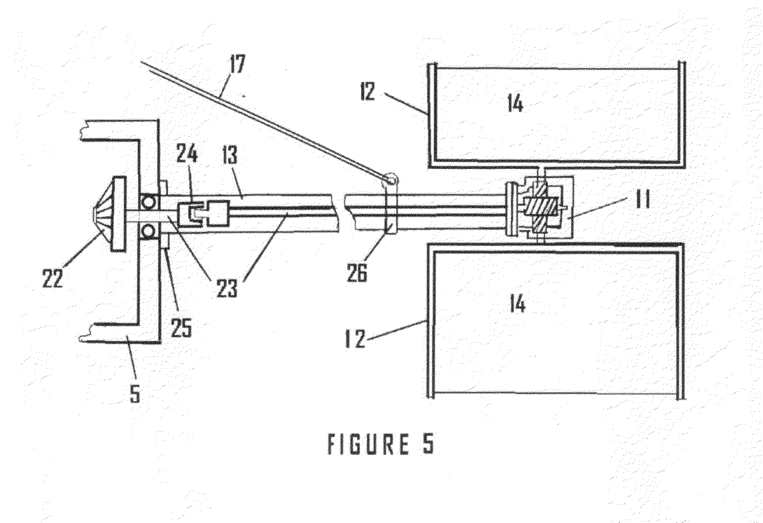

FIG. 6 is a perspective view of a basic non-flexing watermill that can also be deployed in a manner as sketched in FIG. 8. The base 29 may be built up on pilings 39 in a river-bed or in ocean currents where the water flow rate is predictable, and having an upward solid or flexural shaft terminating at a platform housing a generator. The upward drive shaft 15 would be coupled to the load by various means using fittings common to construction.

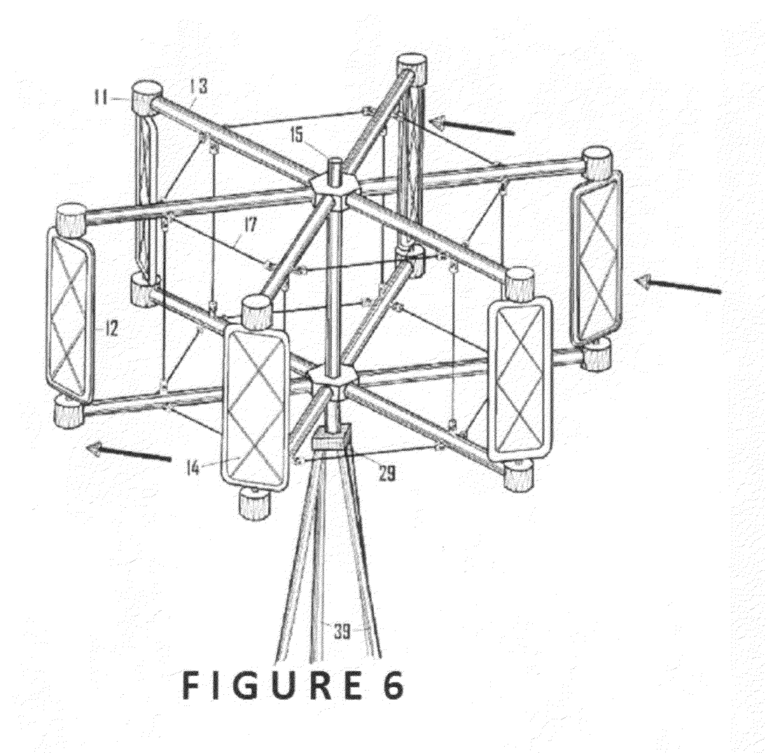

FIG. 7 illustrates a horizontal axis embodiment of this invention having the same components of the vertical axis windmill presented horizontally such that it can be mounted on the roof of tall buildings where it doesn't require a substantially tall support tower. Since air rises against a building it would be convenient to mount the windmill at the edge of the roof so as to dispose the sails fully to the updraft. A variation of it may be mounted in a shallow stream or river as illustrated in this Figure—having blades 14 that dispose openly facing the water flow but progressively dispose to a parallel alignment as they reach the top of their rotation.

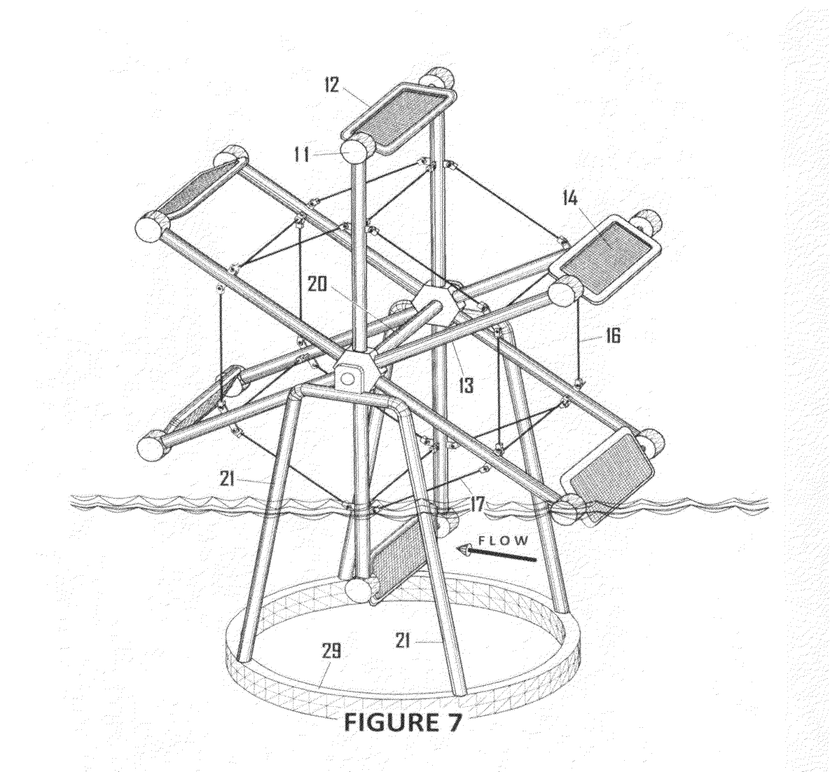

FIG. 8 is a perspective view supporting FIG. 6 which suggests a river installation wherein concrete bases 29 support the work platform 30 and the base of the mill 29. There is no tail with this embodiment because it is assumed the river will flow from a certain direction. The splined drive shaft 20 would permit the watermill to move up and down. A means is provided 36 to crank the mill-head up out of the water by a screw 37 or other means for maintenance purposes. There is no pivot point because it is assumed there will never be an upset condition. A river in flood will still only move at a velocity rate that is no threat to the mill. The platform 30 may have locking storage, walls, windows, or any other improvement deemed necessary or convenient for the owner or operator. All the gearing and controls for the power output are contained in a unit 31 for that purpose, and drives the generator 19 or other load. A shelter 32 is provided to protect the equipment on the platform 30. The substructure may include screens or other diverters to move flotsam away from the sails. The paddles of the BURRELL AXIAL RIVER MILL will be constructed of sturdy material to withstand possible damage from flotsam that cannot be diverted. NOTE: there are two types of objects that flow down a river with the water: things that float, and things that roll on the bottom. The mill will be placed such that the arms, hub, and paddles are in that safe laminar part of the river flow. A means is provided 36 to crank the mill-head up out of the water by a screw 37 or other means for maintenance purposes. The depth under the river surface 35 where the paddles are positioned is determined by historical record of flotsam size and type, which in the Saint Clair & Detroit Rivers wound certainly include ice. It is not the purpose of this invention to show how power is transmitted to off-shore facilities, so no means is shown. Nor did I show how the power gets from the platform to Public Utilities. Common practice for that sort of thing is adequate.

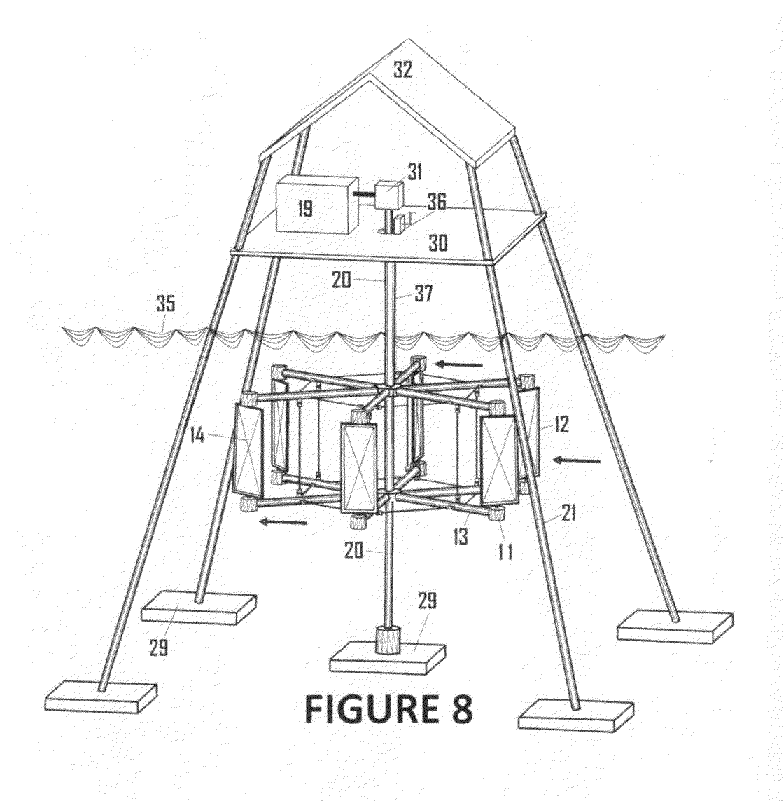

FIG. 9 is a view of a Burrell Compound Vertical Axis Windmill tilted on its universal joint 24, and the work platform 38. It is possible to incorporate automotive type universal joints and continuous velocity joints (CV) as well as other parts of automobiles and trucks, and their use does not defeat the features that makes this invention patentable. In fact, the U.S.P.T.O. allows a new use for an existing tool, etc. as patentable in that application claimed as new. While universal joints have been in existence many years, this invention incorporates it in the design as a new and unique application. And work platforms are common, but this is the first use of it on a windmill tower. Its purpose is to make maintenance of the sail assemblies easier at a lower elevation—which is a safety feature as well as a convenience.

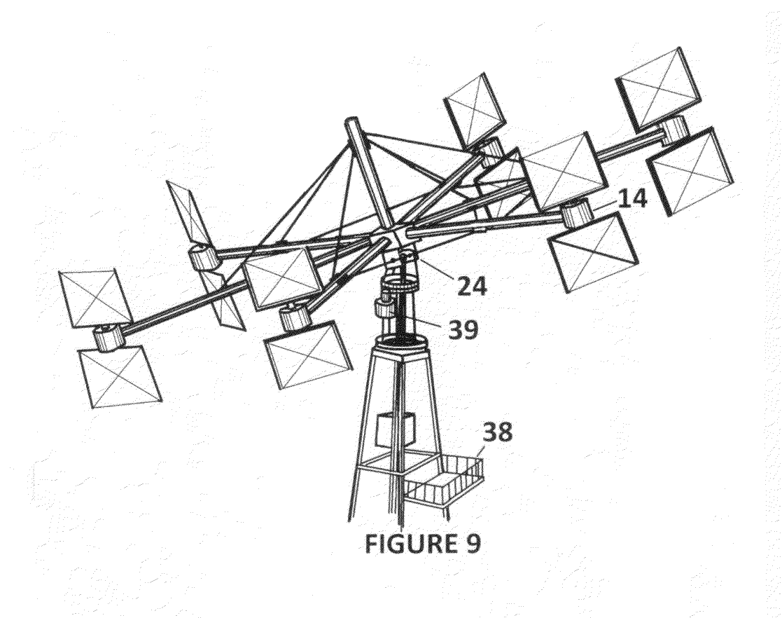

### DETAILED DESCRIPTION OF THE INVENTION

We live in an age that is forced to deal with the possibility of terrorist attack by people with a cause; people with a grudge; people who are sick; people who by rapacity suppose they can impose their will on their neighbors. Terrorists tend to choose Monuments to destroy: Power Plants; Federal Buildings; Shrines, Trains, Airplanes, etc. It is well known that President Theodore didn't travel all the way to Africa to hunt mice. There would be no bragging rights in such a trophy. Our great Interstate Roadway System is a National Defense strategy that gives us mobility in time of adversity. When we replace all the coal, gas, and nuclear fired Power Plants with a profusion of small, medium and large Wind Powered Electric Generating stations the incentive to destroy a single Power Plant so as to create confusion and panic that target is removed. The Burrell Compound Vertical Axis Windmill in all its embodiments from single dwelling units of 1 Kw or less to large commercial units of 100 Kw and larger will reduce or eliminate the need for fossil fuel burning power plants. Power generation will satisfy the need of citizens to participate in the energy independence. The Burrell windmills and watermills are made of inexpensive materials readily available to the industry. Their use is easily understood by mechanics who will assemble them and maintain them. It won't take a rocket scientist to understand the concept, and it won't take a highly trained and skilled mechanic to fix one if it goes bonk! Our patent won't restrict use or maintenance—only the manufacture, purchase, or use of our design.

I claim:

1. A vertical axis windmill comprising a plurality of sail assemblies that rotate about the mill-head—transmitting power generated at the sails to the hub of the mill-head via various mechanical means, said sails providing thrust through their entire rotation: windward, quarter, leeward, and quarter alignments. There are no losses due to a sail in this or that alignment not providing thrust.

2. The vertical axis windmill of claim 1 wherein the sails are composed of fabric, metal, plastic, or other material suitable for the purpose.

3. The vertical axis windmill of claim 1 wherein the hub or sprocket of the windmill assembly transmits power to the generator or other tool through a drive shaft.

4. The vertical axis windmill of claim 1 wherein the gear ratio from sail assembly to the hub is 2:1.

5. The vertical axis windmill of claim 1 wherein the sprocket ratio from the sail assembly to the hub is 2:1.

6. The vertical axis windmill of claim 1 wherein the drive shaft has a stop and bearings at the head of the tower to bear the windmill weight and other forces upon the tower.

7. The vertical axis windmill of claim 1 wherein the attitude of the windmill is fixed in anticipation of a prevailing wind from a certain direction.

8. The vertical axis windmill of claim 1 wherein the attitude of the windmill varies such that the mill always faces windward.

9. The vertical axis windmill of claim 1 wherein the windmill assembly pivots on a continuous velocity (CV) joint or other mechanical device which permits the windmill to yield to varying wind velocities.

10. The vertical axis windmill of claim 1 wherein the support arms from the hub extending to the right angle gearboxes at the sail assemblies are as short as 1 meter or as long as 50 meters and upward as power/torque needs require to drive such-and-such generator or other equipment.

11. The vertical axis windmill of claim 3 wherein the support arms are tubular—housing drive shafts of various materials such as steel, aluminum or other.

12. The vertical axis windmill of claim 3 wherein the support arms are of solid construction to permit use of chain drive or other power transmission means.

13. The vertical axis windmill of claim 1 wherein the transmission tower may be fabricated using steel or aluminum or other members to a height necessary so as to place the windmill in laminar wind-flow.

14. The vertical axis windmill of claim 1 wherein the transmission tower may be tubular and constructed of reinforced concrete, steel, or other metal so as to place the windmill in laminar wind-flow.

15. The vertical axis windmill of claim 9 wherein the windmill assembly pivots such that the support arms may are disposed vertically to permit maintenance of the sail assemblies by a technician standing on a tower platform.

16. The vertical axis windmill of claim 9 wherein the windmill assembly does not pivot.

17. The vertical axis windmill of claim 9 wherein the pivot of the windmill is above the balance point of the windmill so that the windmill at rest is balanced.

18. The vertical axis windmill of claim 9 wherein the support arms for the sail assemblies dispose downward such that a moderate wind-force will not upset the windmill.

19. The vertical axis windmill of claim 9 wherein the sails of the sail assembly rise above the balance point of the windmill such that increasing wind-force will offset the windmill's balance—causing the windmill to yield increasingly toward the upset condition.

20. The vertical axis windmill of claim 9 wherein the force of the wind is diminished as it slips over the tipped sails—permitting continuous power generation in varying wind speeds.

21. The vertical axis windmill of claim 17 wherein the hub or sprocket of the windmill is positioned above the pivot point of the mill head so as to permit a maintenance technician to rotate the horizontal assembly into a vertical disposure for maintenance of the sail assemblies.

22. The vertical axis windmill of claim 20 wherein the hub may be salvaged from the one of the front wheel assemblies including the steering yoke and adapted variously to create a workable windmill.

23. The vertical axis windmill of claim 17 wherein the attitude of the windmill varies as the wind direction changes.
